(19) United States
(12) Patent Application Publication
(10) Pub. No.: US 2007/0103855 A1
(43) Pub. Date: May 10, 2007

(54) Retractable display apparatus

(75) Inventors: Kazushige Hara, Kariya-city (JP); Shinichi Yoshinaka, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/585,113

(22) Filed: Oct. 24, 2006

(30) Foreign Application Priority Data
Nov. 8, 2005 (JP) 2005-323548
Jul. 27, 2006 (JP) 2006-204671

(51) Int. Cl. G06F 1/16

(52) U.S. Cl. 361/681

(57) ABSTRACT

A retractable display apparatus for use in a vehicle includes a main body disposed on a ceiling of the vehicle, a monitor unit rotatably held by the main body, an actuator for generating a driving force, a conversion assembly for perpendicularly converting a transmission direction of the driving force of the actuator, a transmission assembly for driving the monitor unit by transmitting the driving force from the conversion assembly to the monitor unit. The monitor unit is selectively driven to a stored position in a storage space in the main body and an extended position relative to the main body. The actuator is enclosed in the side space of the storage space in the main body. The conversion assembly is enclosed in the side space of the storage space in the main body.

### CROSS REFERENCE TO RELATED APPLICATION

This application is based on and claims the benefit of priority of Japanese Patent Application No. 2005-323548 filed on Nov. 8, 2005, and No. 2006-204671 filed on Jul. 27, 2006, the disclosure of which is incorporated herein by reference.

### FIELD OF THE INVENTION

The present invention generally relates to a display apparatus used in a vehicle.

### BACKGROUND OF THE INVENTION

In recent years, an increased number of automotive vehicles are equipped with a so-called “rear seat entertainment system (RSE)” so that occupants in the rear sheet can watch movies, TV programs or the like. The RSE includes a monitor unit that can be unfolded for viewing and can also be folded into a main body for storage. The monitor unit is more viewable when it is installed on a front part of a ceiling of the vehicle. The monitor unit is unfolded from the main body to be in an extended position by a motor that provides driving force for rotating the monitor unit around a rotation axis, and the driving force from the motor is transmitted to the rotation axis of the monitor unit by a train of gears. Therefore, an axis of the motor and the axis of rotation of the monitor unit are arranged in parallel in a front part of the main body of the RSE. Japanese patent documents JP-A-2004-237895 and JP-A-2005-014847 disclose folding/unfolding mechanisms of the monitor unit in the main body of such system.

However, because of the folding/unfolding mechanisms having the above-described structure in association with the monitor unit, the main body of the RSE has an increased length in a front-rear direction of the vehicle. As a result, the monitor unit unfolded to be in the extended position comes behind the folding mechanism in the main body, thereby being pushed into a relatively rearward position in the vehicle. Further, rearrangement of the folding/unfolding mechanism relative to the monitor unit is difficult, because the axis of the motor has to be arranged in parallel with the axis of rotation of the monitor unit.

### SUMMARY OF THE INVENTION

In view of the above-described and other problems, the present disclosure provides a retractable display apparatus that can be positioned in a front part of a vehicle.

In one aspect of the present disclosure, the retractable display apparatus includes an actuation assembly such as a motor for folding and unfolding a monitor unit in a main body, a conversion assembly for converting a direction of a driving force from the actuation assembly, and a transmission assembly for transmitting the driving force from the conversion assembly to the monitor unit. The actuation assembly and the conversion assembly are positioned laterally in the main body so as to make room for the monitor unit to be installed in a frontward position in the main body. In this manner, the monitor unit is more viewable when unfolded in a space of the vehicle, and the actuation assembly is efficiently housed in the main body.

In another aspect of the present disclosure, the retractable display apparatus uses a worm gear for transmitting the driving force to the monitor unit. In this manner, an increased amount of torque is applied to the monitor unit, thereby preventing the monitor unit from being displaced from an intended position even when vibration of the vehicle vibrates the monitor unit.

In yet another aspect of the present disclosure, the retractable display apparatus has the actuation assembly such as the motor or the like that is disposed in the main body in an angle against a height direction of the main body. In this manner, the height of the retractable display apparatus is reduced.

In still yet another aspect of the present disclosure, the retractable display apparatus uses a combination of large and small gears for increasing a torque of the driving force. In addition, those gears are arranged in a space-efficient manner, thereby enabling the retractable display apparatus to have a smaller package size by reducing both of a longitudinal and a lateral dimensions of the main body.

### BRIEF DESCRIPTION OF THE DRAWINGS

Other objects, features and advantages of the present invention will become more apparent from the following detailed description made with reference to the accompanying drawings, in which:

FIG. 1 shows an side view illustration of an actuation assembly of a retractable display apparatus in an embodiment of the present disclosure;

FIG. 2 shows a cross-sectional view of a train of gears in the actuation assembly;

FIG. 3 shows an expanded cross-sectional view of a, first gear in the train of gears;

FIG. 4 shows a perspective view of the retractable display apparatus with a monitor unit stored in a storage space;

FIG. 5 shows a perspective view of the retractable display apparatus with the monitor unit flipped to an extended position;

FIG. 6 shows a top view of the retractable display apparatus with partial cross sections;

FIG. 7 shows a perspective view of a lock assembly of the retractable display apparatus;

FIG. 8 shows a side view of the lock assembly of the retractable display apparatus;

FIG. 9 shows a block diagram of a car navigation system in the present disclosure; and

FIG. 10 shows a flowchart of a close operation process of the retractable display apparatus.

### DETAILED DESCRIPTION OF THE PREFERRED EMBODIMENTS

Embodiments of the present invention are described with reference to the drawings. Like parts have like numbers in each of the embodiments.

A retractable display apparatus is disclosed as a navigation system in the present embodiment.

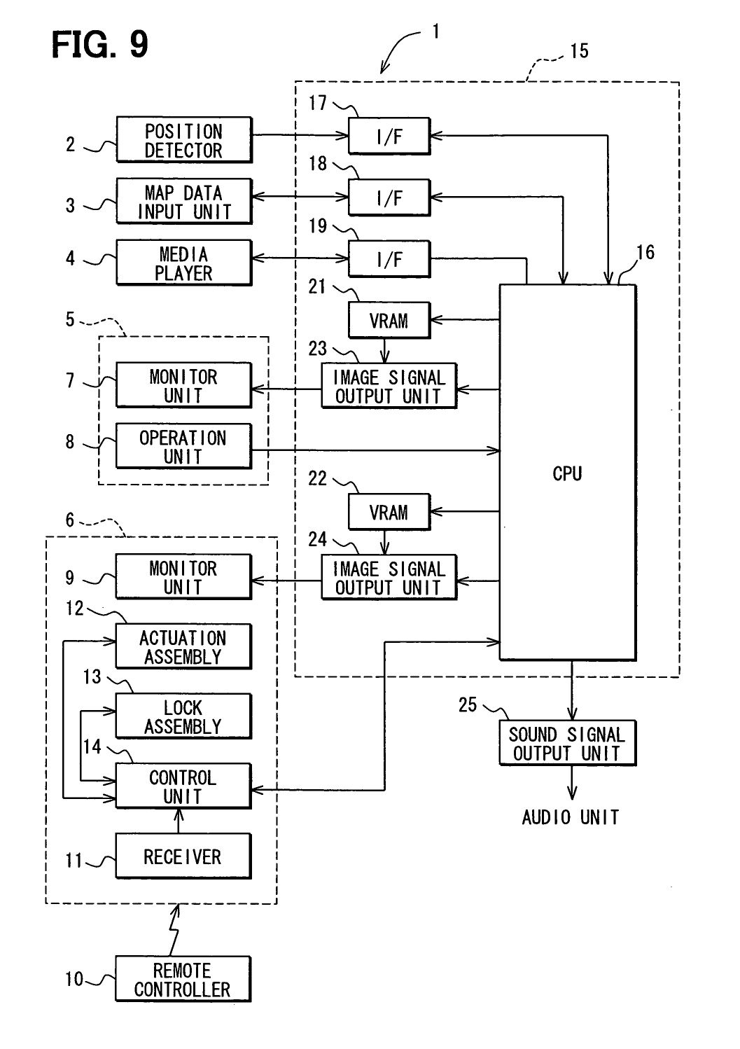

FIG. 9 shows a block diagram of the navigation system 1. The navigation system 1 includes a position detector 2 with a GPS receiver for determining a current position of a vehicle based on a GPS signal installed therein, a map data input unit 3 for retrieving map data and facility data from information medium such as a hard disk or the like, a media player 4 for retrieving image data and sound data from a DVD-ROM or the like, a front monitor 5 to be viewed by occupants in front seats of the vehicle, and a back monitor 6 to be viewed by occupants in seats of the vehicle. The front monitor 5 and the back monitor 6 are used to display travel information such as a road map, a navigation route, a facility, and/or an image of an entertainment program recorded on the DVD-ROM.

The front monitor 5 is installed in an instrument panel, and is used to display the travel information and/or images for a driver of the vehicle. The back monitor 6 is installed on a ceiling of the vehicle, and is used to display the images for the occupants of the back seats as a rear seat entertainment system (RSE). The front monitor 5 includes a monitor unit 7 that uses a liquid crystal display unit and an operation unit 8 for input operations. The back monitor 6 includes a monitor unit 9 that uses the liquid crystal display unit, a receiver 11 for receiving a signal from a remote controller 10, an actuation assembly 12 for opening and closing the monitor unit 9, a lock assembly 13 for locking the monitor unit 9, and a control unit 14 that controls operation of the actuation assembly 12 and the lock assembly 13.

The position detector 2, the map data input unit 3, the media player 4, the front monitor 5, and the back monitor 6 are coupled with a control unit 15 of the navigation system 1 that controls display operation on those components. The control unit 15 includes a CPU 16 that provides computing function, and receives signals from the position detector 2, the map data input unit 3, and the media player 4 through an interface (I/F) 17, 18, 19.

The control unit 15 also includes video RAMs (VRAMs) 21, 22 for storing image data, and image output units 23, 24 for outputting the image signal after converting the image data in the VRAMs 21, 22. The monitor units 7, 9 in the front/back monitor 5, 6 display image based on the image signal from the image output units 23, 24.

The control unit 15 further includes a sound signal output unit 25 that controls conversion of sound data of the travel information and output of guidance voice based on the travel information from an audio system including an amplifier/a speaker or the like.

The control unit 15 in the navigation system 1 receives various instruction inputs from users that controls the operation unit 8 in the front seats and/or the remote controller 10 in the back seats. The CPU 16 in the control unit 15 conducts a calculation operation, displays the travel information, road map, guidance image and/or control menus for setting a destination or for setting system configuration or the like on the monitor units 7, 9 based on the inputted instructions. Further, the CPU 16 controls output of control signals from the sound signal output unit 25 for the guidance voice that guides the travel information, setting operations or the like.

FIG. 6 shows a top view of the retractable display apparatus with partial cross sections included therein. The retractable display apparatus is used as the back monitor 6 in the present embodiment, and has a body 26 and the monitor unit 9 housed in a storage space 26a. The monitor unit 9 opens and closes from/to the storage space 26a upon receiving instructions on the remote controller 10 from the user.

The back monitor 6 has the actuation assembly 12 in a side space of the storage space 26a. The actuation assembly 12 is used to open/close the monitor unit 9. The back monitor 6 also has the lock assembly 13 in a rear space of the storage space 26a.

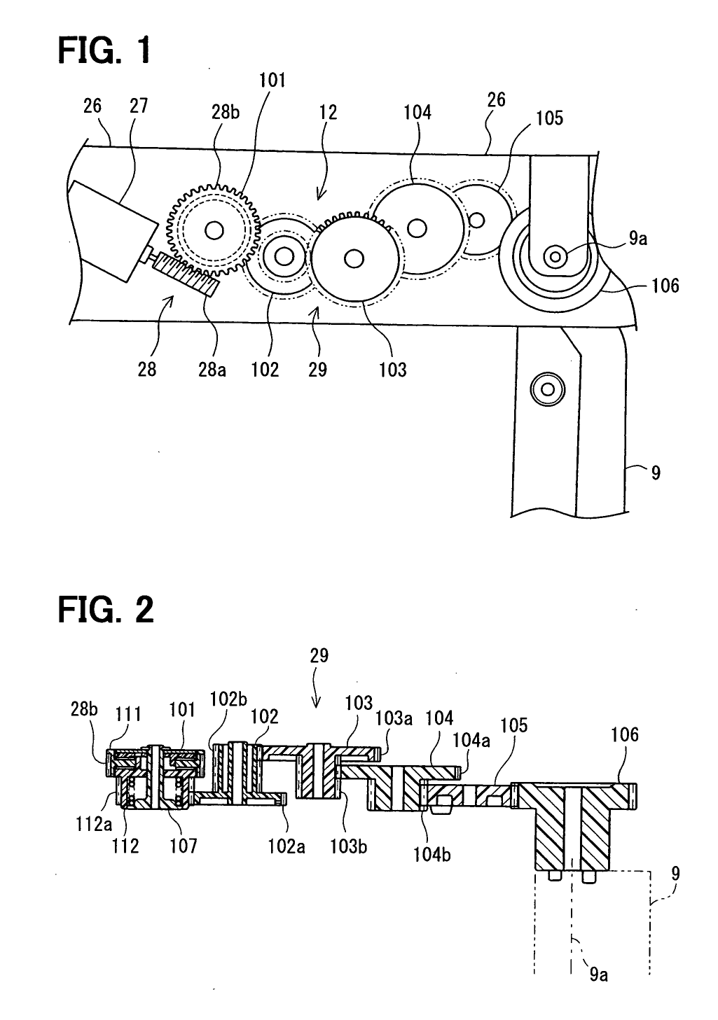

FIG. 1 shows a side view illustration of the actuation assembly 12 of the back monitor 6. The actuation assembly 12 includes a flip actuator 27, a worm gear 28, and a gear train 29. The flip actuator 27 is disposed on a plane that is perpendicular to an axis 9a of the monitor unit 9, and is positioned in an angle against a height direction of the body 26 of the back monitor 6. The flip actuator 27 has a worm 28a on its shaft, and the worm 28a engages a worm wheel 28b that is a part of the gear train 29. Rotation of the worm wheel 28b is transmitted to rotate the axis 9a with an increased torque through the gear train 29. Material used to make the worm gear 28 and the gear train 29 is a polyacetal (i.e., polyoxymethylene:POM) that is qualified to endure the vibration of the vehicle.

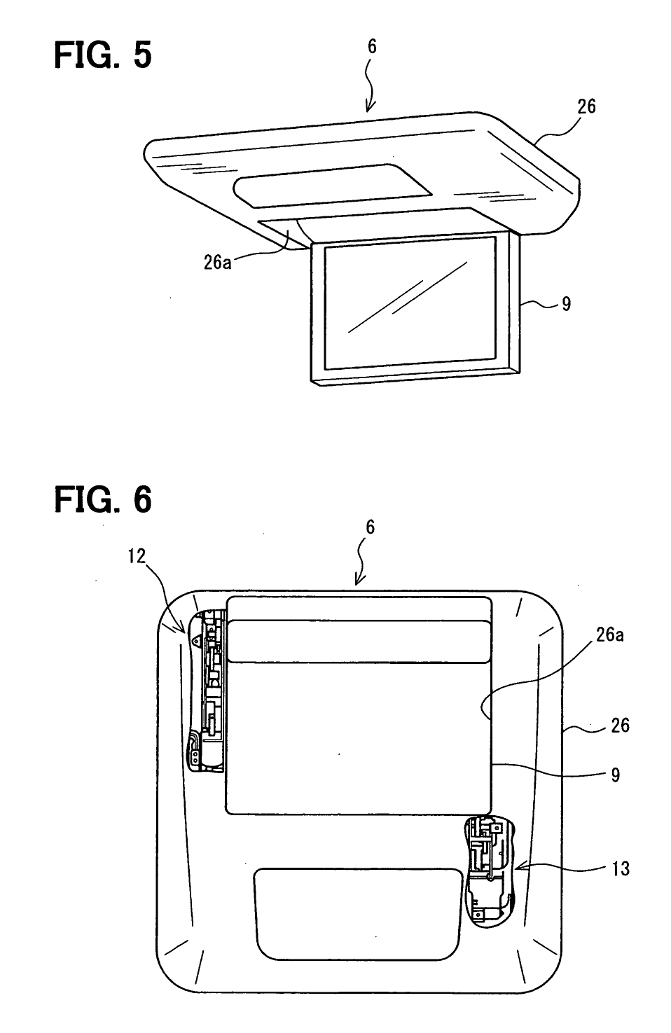

The flip actuator 27 rotates in a normal direction to swingingly raise the monitor unit 9 from a stored position in the storage space 26a (refer to FIG. 4) to an extended position (refer to FIG. 5), and also rotates in a reverse direction to swing back the monitor unit 9 from the extended position to the stored position. The CPU 16 detects a position of the monitor unit 9 by a position sensor (not shown in the figure), and controls the flip actuator 27 based on the detected position of the monitor unit 9.

FIG. 2 shows a cross section of the gear train 29. The gear train 29 includes the worm wheel 28b, a first to fifth gears 101 to 105, and a monitor gear 106. The first gear 101 is integrally formed with the worm wheel 28b. As the worm wheel 28b rotates, the first to fifth gears and the monitor gear 106 rotate. As a result, the monitor unit 9 combined with the monitor gear 106 rotates back and forth according to the rotation of the worm wheel 28b.

Each of the first to fourth gears 101 to 104 is a combination of two flat gears. Two flat gears in each of the first to fourth gears 101 to 104 have respectively different diameters, that is, a small and a large gears are combined to form each of the four gears. The first to fourth gears 101 to 104 are engaged with each other in a small to large coupling in order. That is, the small gear of the first gear 101 drives the large gear of the second gear 102, and the small gear of the second gear 102 drives the large gear of the third gear 103. In this manner, the torque of the rotation generated by the flip actuator 27 is amplified to drive the monitor gear 106.

The first gear 101 in the gear train 29 is a combination of two gears, that is, a first clutch gear 111 that includes the worm wheel 28b as the large gear, and a second clutch gear 112 that includes a flat gear 112a as the small gear. The second to fourth gears 102 to 104 respectively includes large gears 102a to 104a, and small gears 102b to 104b. The fifth gear 105 is the flat gear.

The first to third gears 101 to 103 in the gear train 29 are arranged in a staggered manner in a longitudinal direction of the vehicle, that is, the engagement of the small and the large gears alternates sides in order. Therefore, the actuation assembly 12 has a reduced size in both of the lateral and the longitudinal directions.

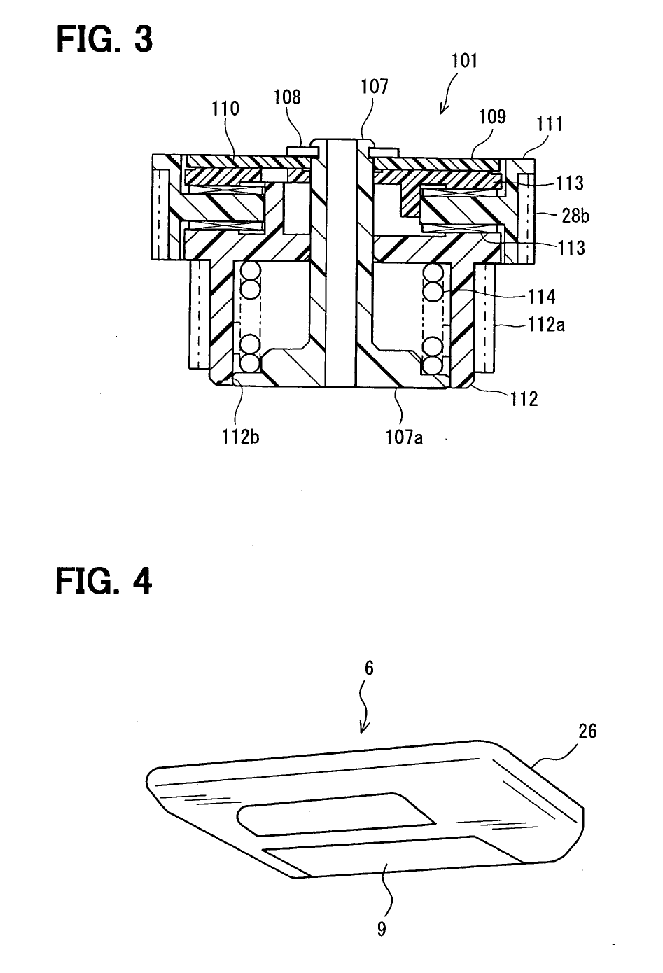

The first gear 101 has a clutch mechanism installed therein as shown in FIG. 3. The clutch mechanism in the cross-sectional view in FIG. 3 has a clutch shaft 107 having a flange 107a on one end, and the clutch shaft 107 holds an E ring 108, a clutch washer 109, a clutch plate 110, the first clutch gear 111, and the second clutch gear 112 in order. The second clutch gear 112 is a cylinder having a bottom on one end. An outer periphery of the flange 107a of the clutch shaft 107 is rotatably supported by an opening 112b of the cylinder in the second clutch gear 112. An outer surface of the first clutch gear 111 has the worm wheel 28b of the warm gear 28. An outer surface of the second clutch gear 112 has the flat gear 112a. The first clutch gear 111 is bound by the clutch plate 110 and the second clutch gear 112 with a layer of a felt 113 interposed therebetween. The second clutch gear 112 is pressed against the first clutch gear 111 by a spring compressed between an inner bottom of the cylinder of the second clutch gear 112 and the flange 107a of the clutch shaft 107. In this manner, a predetermined amount of friction is applied to the first clutch gear 111 by the clutch plate 110 and the second clutch gear 112.

The clutch mechanism in the first gear 101 described above is used to rotate the second clutch gear 112 as the first clutch gear 111 (i.e., the worm wheel 28b) is driven by the flip actuator 27 with the worm 28a engaged therewith. The first clutch gear 111 and the second clutch gear 112 rotate together when a load on the second clutch gear 112 is light. When a heavy load is applied to the second clutch gear 112, the second clutch gear 112 slips on the first clutch gear 111. In this manner, the monitor unit 9 is allowed to rotate frontward from the extended position upon application of a pushing force on the monitor unit 9, thereby protecting the actuation assembly 12 from breakage. Similarly, the actuation assembly 12 is protected when, for example, the monitor unit 9 holds an object in a gap in the course of closing operation into the storage space 26a by a driving force of the flip actuator 27.

The actuation assembly 12 having the above-described advantage is used to open and close the monitor unit 9 in combination with the flip actuator 27. The actuation assembly 12 is efficiently housed in a side space of the storage space 26a in the present embodiment.

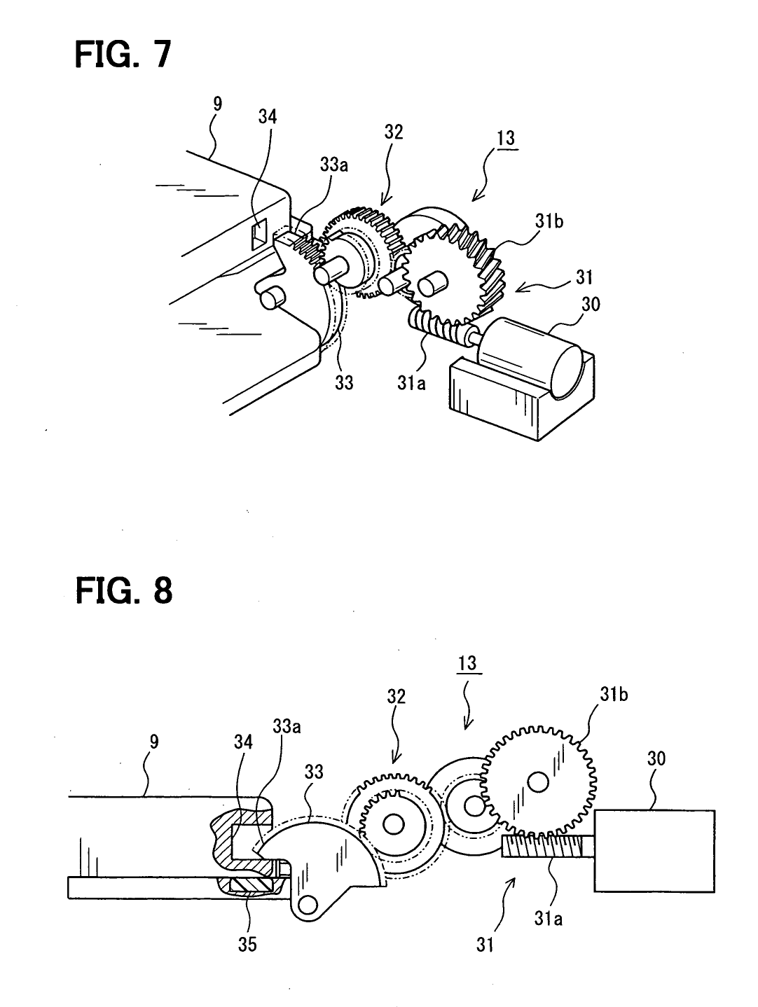

FIG. 7 shows a perspective view of the lock assembly 13 of the retractable display apparatus. The lock assembly 13 includes a lock actuator 30, a worm gear 31, a gear train 32, and a lock cam 33. The lock actuator 30 is disposed in parallel with a lateral axis of the body 26. The lock actuator 30 has a worm 31a on its shaft, and the worm 31a engages a worm wheel 31b disposed on the body 26 to be used as the worm gear 31. Rotation of the worm wheel 31b is transmitted to the lock cam 33 through the lock assembly 13 with an increased amount of torque. The lock cam 33 has a gear on its outer surface, an the gear on the lock cam 33 engages the last gear of the gear train 32. In this manner, the lock actuator 30 drives the lock cam 33, and the lock cam 33 holds the monitor unit 9. More practically, a lock finger 33a on one end of the lock cam 33 engages a lock hole 34 in a concave shape on the monitor unit 9. That is, when the monitor unit 9 is positioned in the storage space 26a, rotation of the lock cam 33 fastens the monitor unit 9 by engaging the lock finger 33a with the lock hole 34 as shown in FIG. 8. Material used to make the worm gear 31, the gear train 32 and the lock cam 33 is a polyacetal (i.e., polyoxymethylene:POM) that is qualified to endure the vibration of the vehicle.

The lock actuator 30 rotates in the normal direction to release the lock finger 33a from the lock hole 34 by driving the lock cam 33 from a lock position to an unlock position, and the lock actuator 30 rotates in the reverse direction to lock the lock finger 33a with the lock hole 34. The control unit 14 detects and determines a position of the lock cam 33 by a position sensor (not shown in the figure).

The body 26 has an elastic member 35 at a position where a periphery of the lock hole 34 in the monitor unit 9 is abutted. More practically, the elastic member is disposed in the body 26 with its head protruding therefrom. The elastic member 35 is made of elastomer, and a material of the elastic member 35 is carefully chosen to avoid interference with a resin that is used to form the body 26 and the monitor unit 9.

The lock assembly 13 is used to lock the monitor unit 9 in the storage space 26a in the above-described advantageous manner.

The operation of the retractable display apparatus is described in the following.

The control unit 14 executes a close operation of the monitor unit 9 upon receiving a close instruction on the remote controller 10. The control unit 14 also executes the close operation upon detecting a shut off of an engine of the vehicle when the shut-off of the engine is associated with the close operation in configuration setting.

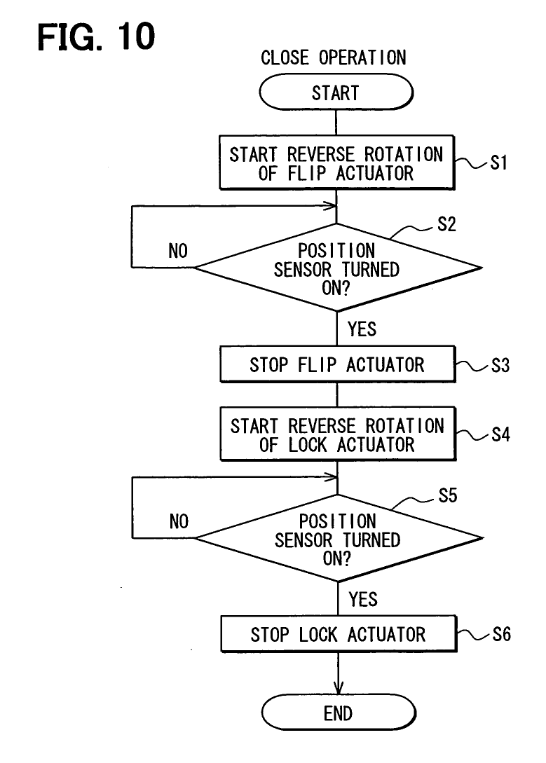

FIG. 10 shows a flowchart of a close operation process of the retractable display apparatus, that is, the close operation process of the monitor unit 9 in the back monitor 6 controlled by the control unit 14. The control unit 14 also controls an open operation of the monitor unit 9. The description of the open operation is omitted for the brevity of the explanation because it has a reversed order of the steps in the close operation. The monitor unit 9 of the back monitor 6 is raised to be in the extended position at a start of the close operation process as shown in FIG. 5.

In step S1, the process in the control unit 14 starts a reverse rotation of the flip actuator 27. The monitor unit 9 is driven to rotate from the extended position to the stored position according to the rotation.

In step S2, the process determines whether the monitor unit 9 is rotated to the stored position by using the position sensor. That is, the position sensor is turned on when the monitor unit 9 rotates to be in the stored position (step S2:YES).

In step S3, the process stops the rotation of the flip actuator 27. The monitor unit 9 stops rotation in the storage space 26a.

In step S4, the process in the control unit 14 starts the reverse rotation of the lock actuator 30. The lock cam 33 is driven by the rotation of the lock actuator 30, and the lock finger 33a in the lock cam 33 presses the lock hole 34 in the monitor unit 9 as the lock cam 33 rotates from the unlock position to the lock position.

In step S5, the process determines whether the lock cam 33 is in the lock position by using the position sensor. That is, the position sensor is turned on when the lock cam 33 rotates to be in the lock position.

In step S6, the process stops the reverse rotation of the lock actuator 30.

In the above-described manner, the monitor unit 9 is positioned in the storage space 26a with the periphery of the monitor unit 9 held by the lock cam 33 and the elastic member 35.

In the present embodiment, an installation of the monitor unit 9 at a front end of the body 26 of the back monitor 6 is realized by arranging the enclosure of the actuation assembly 12 in the side space of the storage space 26a in a more efficient manner. Therefore, the visibility of the monitor unit 9 is improved in comparison with the conventional back monitor that has the actuation assembly 12 at the front end of the body.

In addition, the worm gear 28 is used to drive the monitor unit 9 in combination with the flip actuator 27. Therefore, the monitor unit 9 is securely held in the extended position and displacement of the monitor unit 9 from the extended position due to the vibration of the vehicle applied to the monitor unit 9 is prevented.

Further, the actuation assembly 12 uses the gear train 29 arranged in a space efficient manner, thereby enabling the back monitor 6 to have a reduced package size in both of the lateral and longitudinal directions.

In addition, the flip actuator 27 is disposed in an angle against the height direction of the body 26, thereby enabling a reduced package size of the back monitor 6 in terms of the height of the body 26.

Although the present invention has been fully described in connection with the preferred embodiment thereof with reference to the accompanying drawings, it is to be noted that various changes and modifications will become apparent to those skilled in the art.

For example, the rotation of the flip actuator 27 may be transmitted by using a bevel gear.

Further, the actuation assembly 12 may be housed in both sides of the storage space 26a in the body 26.

Furthermore, the monitor unit 9 unfolded and folded by the actuation assembly 12 may be a different device. For example, a lighting unit may be folded and unfolded in and out from the main body 26 instead of the monitor unit 9 by the actuation mechanism arranged in the above described manner.

Such changes and modifications are to be understood as being within the scope of the present invention as defined by the appended claims.

What is claimed is:

1. A retractable apparatus comprising:
a main body disposed on a surface of an external structure;
a function unit rotatably held by the main body, wherein the function unit is selectively driven to a stored position in a storage space in the main body and an extended position relative to the main body;
an actuator for generating a driving force, wherein the actuator is enclosed in a side space of the storage space in the main body;
a conversion assembly for generally perpendicularly converting a transmission direction of the driving force of the actuator, wherein the conversion assembly is enclosed in the side space of the storage space in the main body; and
a transmission assembly for driving the function unit by transmitting the driving force from the conversion assembly to the function unit.

2. The retractable apparatus as in claim 1,
wherein the conversion assembly is a worm gear.

3. The retractable apparatus as in claim 1,
wherein the actuator disposed in the main body has an angle relative to a height direction of the main body.

4. The retractable apparatus as in claim 1,
wherein the transmission assembly includes a train of coaxial double gears,
each of the coaxial double gears includes two gears having respectively different diameters in a parallel arrangement, and
a smaller gear in one coaxial double gear engages a larger gear in another coaxial double gear in the train of the coaxial double gears in a staggered manner along a longitudinal direction of the main body so as to increase a torque of the driving force in a course of transmission therethrough.

5. The retractable apparatus as in claim 1,
wherein the surface of the external structure is a ceiling of a vehicle.

6. The retractable apparatus as in claim 1,
wherein the function unit is a display device for displaying an image.
